(19) United States
(12) Patent Application Publication
(10) Pub. No.: US 2026/0254027 A1
(43) Pub. Date: Aug. 27, 2026

(54) BATTERY MODULE

(71) Applicant: TOYOTA JIDOSHA KABUSHIKI KAISHA, Toyota-shi (JP)

(72) Inventor: Yukiko IBE, Toyota-shi (JP)

(73) Assignee: TOYOTA JIDOSHA KABUSHIKI KAISHA, Toyota-shi (JP)

(21) Appl. No.: 19/434,106

(22) Filed: Dec. 29, 2025

(30) Foreign Application Priority Data
Feb. 25, 2025 (JP) 2025-028059

(51) Int. Cl. H01M 50/242; H01M 50/209; H01M 50/291

(52) U.S. Cl. CPC H01M 50/242; H01M 50/209; H01M 50/291

(57) ABSTRACT

A battery module includes: battery cells each including a case and an electrode body housed inside the case; and plate-shape insulators. The battery cells and the insulators are alternately laminated in a first direction. Each of the insulators includes an elastic member in contact with a laminated surface of the case facing the first direction. The elastic member includes a first elastic member formed in a frame shape along a periphery of the laminated surface and contacting the periphery, and a second elastic member disposed inside the first elastic member, the second elastic member being formed in a substantially rectangular shape so as to face the central portion of the laminated surface. Hardness of the first elastic member is higher than the second elastic member, and the second elastic member is made of a material having characteristic of decreasing hardness at high temperatures and increasing hardness at low temperatures.

The present application claims priority to and incorporates by reference the entire contents of Japanese Patent Application No. 2025-028059 filed in Japan on February 25, 2025.

### BACKGROUND

The present invention relates to a battery module.

JP2014002907A discloses a battery module including a plurality of battery cells and partition members disposed between adjacent battery cells, wherein the partition members have an expansion/contraction region that accommodates expansion and contraction of the battery cells.

### SUMMARY

In the configuration described in JP2014002907A, in order for the partition members to follow the expansion and contraction of the battery cells when they expand or contract, it was necessary for multiple partition members to be fastened by fastening members. The configuration described in JP2014002907A required a structure where multiple partition members were fastened by fastening members and did not contemplate a structure where multiple partition members were not fastened by fastening members.

There is a need for a battery module in which a plate-shaped member can follow load changes due to expansion and contraction of the battery cell in a structure having a laminate body alternately laminated with the battery cell and a plate-shaped member.

According to one aspect of the present disclosure, there is provided a battery module including: battery cells each including a case and an electrode body housed inside the case; and plate-shape insulators, wherein the battery cells and the insulators are alternately laminated in a first direction, each of the insulators includes an elastic member in contact with a laminated surface of the case facing the first direction; the elastic member includes a first elastic member formed in a frame shape along a periphery of the laminated surface as viewed from the first direction and contacting the periphery, and a second elastic member disposed inside the first elastic member as viewed from the first direction, the second elastic member being formed in a substantially rectangular shape so as to face the central portion of the laminated surface, hardness of the first elastic member is higher than hardness of the second elastic member, and the second elastic member is made of a material having characteristic of decreasing hardness at high temperatures and increasing hardness at low temperatures.

### BRIEF DESCRIPTION OF THE DRAWINGS

FIG. 1 schematically shows a battery module in an embodiment;

FIG. 2 shows a cross-sectional view of a battery cell and an insulating material;

FIG. 3 shows a view of the insulating material from the stacking direction;

FIG. 4 illustrates a case where the battery cell expands;

FIG. 5 is a diagram illustrating the first elastic member;

FIG. 6 is a diagram illustrating the second elastic member;

FIG. 7 is a cross-sectional view showing the insulating material in a modified example;

FIG. 8 is a diagram illustrating the insulating material in the modified example; and

FIG. 9 is a diagram illustrating the state when the battery cell in contact with the insulating material in a modified example expands.

### DETAILED DESCRIPTION

The battery module in an embodiment of the present disclosure will now be described in detail. Note that the present disclosure is not limited to the embodiment described below.

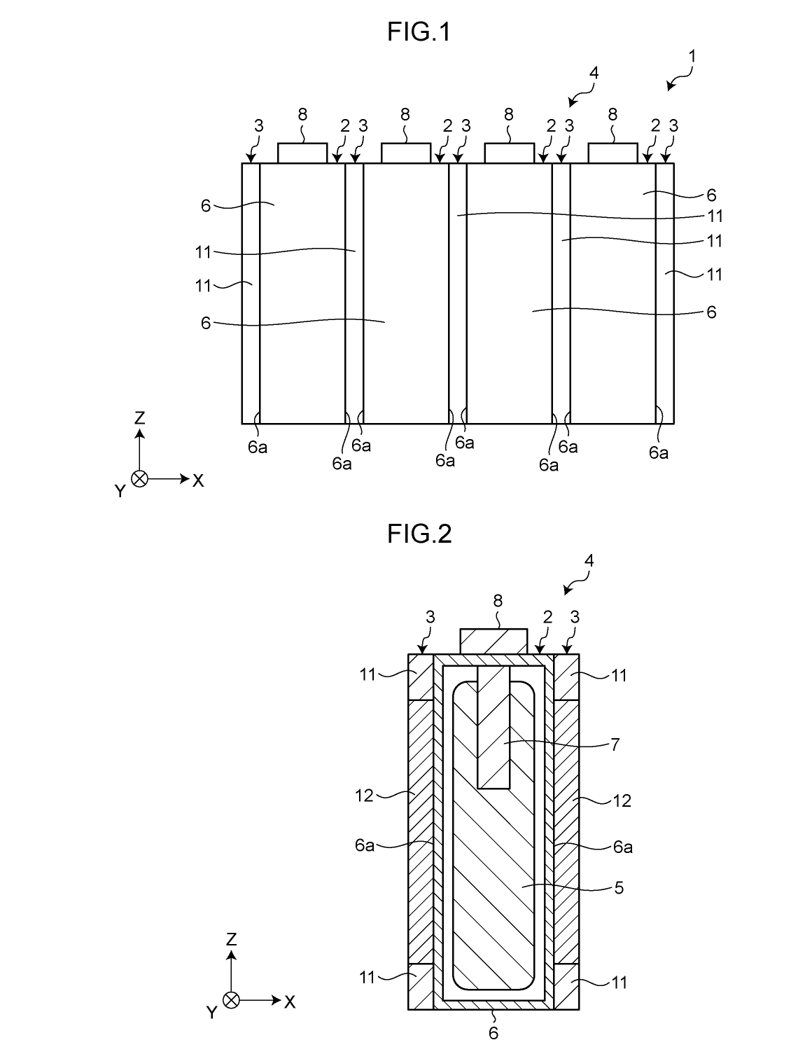

FIG. 1 is a schematic diagram showing the battery module in an embodiment. The battery module 1 is included in the battery pack mounted in an electric vehicle, such as a plug-in hybrid electric vehicle (PHEV) or a battery electric vehicle (BEV). The battery pack mounted in the electric vehicle includes a plurality of battery modules 1. The battery module 1 is a battery pack including a plurality of individual cells. The battery module 1 is a high-voltage battery and a large-capacity battery.

The battery module 1 includes a plurality of battery cells 2 and a plurality of insulating materials (insulators) 3. The battery module 1 has a laminated body 4 in which the battery cells 2 and the insulating materials 3 are alternately stacked in a first direction. The first direction is the same as the stacking direction of the laminated body 4. The first direction coincides with the X-direction.

The battery cell 2 is a prismatic cell. The battery cell 2 is composed of a lithium-ion rechargeable battery. In the battery module 1, a plurality of battery cells 2 are arranged side by side in the stacking direction.

The insulating material 3 is a spacer placed between adjacent battery cells 2 in the stacking direction. The insulating material 3 is a plate-like member in contact with the surface of the battery cell 2.

The stacked body 4 is restrained by restraining members such as restraint bands. A restraining force in the stacking direction is applied to the stacked body 4 from the restraining members. This restraining force holds the stacked body 4 integrally. A restraining force acts on the battery cell 2 from the insulating material 3.

FIG. 2 is a cross-sectional view showing the battery cell and the insulating material. The battery cell 2 includes an electrode body 5, a case 6, a current collector member 7, an external terminal 8, and an electrolyte. The insulating material 3 includes a first elastic body 11 and a second elastic body 12.

The electrode body 5 is a flat rolled body formed by rolling a laminate composed of a positive electrode sheet and a negative electrode sheet stacked via a separator. The electrode body 5 includes a strip-shaped positive electrode sheet, a strip-shaped negative electrode sheet, and a strip-shaped separator. The laminate before rolling is stacked in the thickness direction in the order: positive electrode sheet, separator, negative electrode sheet, separator. The positive electrode sheet includes a positive electrode current collector and a positive electrode active material layer. The positive electrode current collector is a long-length positive electrode base material. The positive electrode active material layer is provided on the positive electrode current collector. The positive electrode current collector includes a positive electrode side uncoated portion where the positive electrode active material layer is not formed at one end in the width direction, exposing the positive electrode current collector. The uncoated cathode side portion forms the cathode current collector when the cathode sheet is wound. A cathode current collector member 7 is connected to the cathode current collector portion. The cathode current collector member 7 is electrically connected to an external terminal 8, which serves as the cathode terminal. The anode sheet includes an anode current collector and an anode active material layer. The negative electrode current collector is a long negative electrode base material. The negative electrode active material layer is provided on the negative electrode current collector. The negative electrode current collector includes an uncoated portion on the negative electrode side where the negative electrode active material layer is not formed and the negative electrode current collector is exposed at the other end in the width direction. The uncoated portion on the negative electrode side forms the negative electrode current collector section when the negative electrode sheet is rolled. A negative side current collector member 7 is connected to the negative electrode current collector portion. The negative side current collector member 7 is electrically connected to an external terminal 8, which serves as the negative terminal. The separator of the electrode body 5 is a porous resin member for retaining electrolyte between the positive electrode sheet and the negative electrode sheet. The separator is a non-woven fabric with high insulation properties. When the electrode body 5 is immersed in the electrolyte, the electrolyte permeates from the edges of the separator toward its center.

The case 6 is a case for housing the electrode body 5. The case 6 is formed in a roughly rectangular prism shape. The case 6 is a metal case. For example, the case 6 is composed of aluminum or an aluminum alloy. The case 6 has a pair of stacking surfaces 6a facing the thickness direction of battery cell 2. The stacking surfaces 6a are the surfaces subjected to restraining force from the outside of battery cell 2. The stacking surfaces 6a are pressed by insulating material 3 in the state of stacking body 4. The inner surface of the case wall section, with the stacking surfaces 6a as its outer surface, faces the flat surface of electrode body 5 in the stacking direction. The case 6 includes a case body and a lid body. The case body is a housing having an opening at its top. The lid body is joined to the case body such that it closes the opening of the case body. The case body and lid body are joined by welding. The interior of the case 6 is sealed. The electrode body 5, the current collector member 7, and the electrolyte are housed inside the case 6.

The current collector member 7 is a pair of metal parts connected to both ends of the electrode body 5. For example, the current collector member 7 is composed of metal foil or metal current collector terminals. The current collector member 7 includes a positive electrode current collector member and a negative electrode current collector member. The positive electrode current collector is positioned at one end in the width direction of the case 6 and is bonded to the positive electrode current collection portion of electrode body 5. The positive electrode current collector is composed of aluminum. The negative electrode current collector is positioned at the other end in the width direction of the case 6 and is bonded to the negative electrode current collection portion of electrode body 5. The negative electrode current collector is composed of copper. The width direction of the case 6 is the same direction as the width direction of battery cell 2 and coincides with the Y-direction. The thickness direction of battery cell 2 coincides with the X-direction. The height direction of battery cell 2 coincides with the Z-direction.

External terminals 8 are a pair of metal parts provided on both ends in the width direction of the case 6 and are formed on the cover body. The external terminals 8 are connected to current collector member 7 and exposed outside the case 6. The external terminals 8 include a positive terminal and a negative terminal. The positive terminal is positioned at one end in the width direction of the case 6 and is electrically connected to the positive electrode current collector member. The negative terminal is positioned at the other end in the width direction of the case 6 and is electrically connected to the negative electrode current collector member.

In the battery module 1 configured as described, a gap exists between the electrode body 5 and the case 6 inside the battery cell 2. Therefore, if the electrode body 5 oscillates due to external inputs such as vibration or shock, stress is applied to the current collector 7, posing a risk of damage to the current collector 7. This phenomenon is more likely to occur under low-temperature conditions when the linear expansion coefficient significantly decreases, or under low SOC conditions when the battery cell 2 lacks energy and the electrode body 5 becomes thin. Conversely, under high-temperature or high-SOC conditions, the battery cell 2 tends to expand. This causes the case 6 to exert a load pushing outward from the inside. Repeated charging and discharging subjects the restraining member to repeated loading, potentially leading to fatigue failure. To hold the electrode body 5 from the outside of the battery cell 2, the insulating material 3 must use a hard material to press the electrode body 5 inward from the outside. Conversely, to absorb deformation of the battery cell 2, the insulating material 3 must be made of a soft material to absorb the load. To satisfy these two conflicting functions, the insulating material 3 incorporates a first elastic body 11 made of a hard material and a second elastic body 12 made of a soft material. However, increasing the thickness of the elastic bodies lengthens the module, worsening the mountability of the battery module 1. Furthermore, increasing the module weight degrades vehicle performance. Therefore, in the battery module 1, the two elastic bodies are combined within a single insulating material 3 without overlapping in the thickness direction. This satisfies the conflicting requirements while suppressing size and weight. The insulating material 3 is configured to achieve these two conflicting purposes.

The insulating material 3 absorbs loads and impacts to prevent stress from being applied to the components of the battery module 1 and causing damage or cracks when the battery cell 2 expands under high SOC or high temperature conditions. An insulation material 3 fixes electrode body 5 to prevent damage to current collector member 7, which connects external terminal 8 to electrode body 5, from occurring due to relative movement of electrode body 5 within the case 6 under external force when battery cell 2 contracts at low SOC or low temperatures, thereby preventing electrical contact failure.

The insulating material 3 includes an elastic member including a first elastic body 11 and a second elastic body 12. The elastic member contacts the stacking surface 6a of the case 6, which faces the stacking direction. The elastic member is a flat plate portion facing the battery cell 2 in the stacking direction and is formed to be approximately the same size as the stacking surface 6a. The elastic member is shaped such that its entire surface contacts the stacking surface 6a. The elastic member is composed of a material exhibiting temperature-dependent hardness, becoming softer with reduced hardness under high-temperature conditions and harder with increased hardness under low-temperature conditions. The first elastic member 11 and the second elastic member 12 are composed of a resin containing elastic components, such as an elastomer, to absorb deformation during expansion of the battery cell 2 and to hold the electrode body 5 during contraction of the battery cell 2.

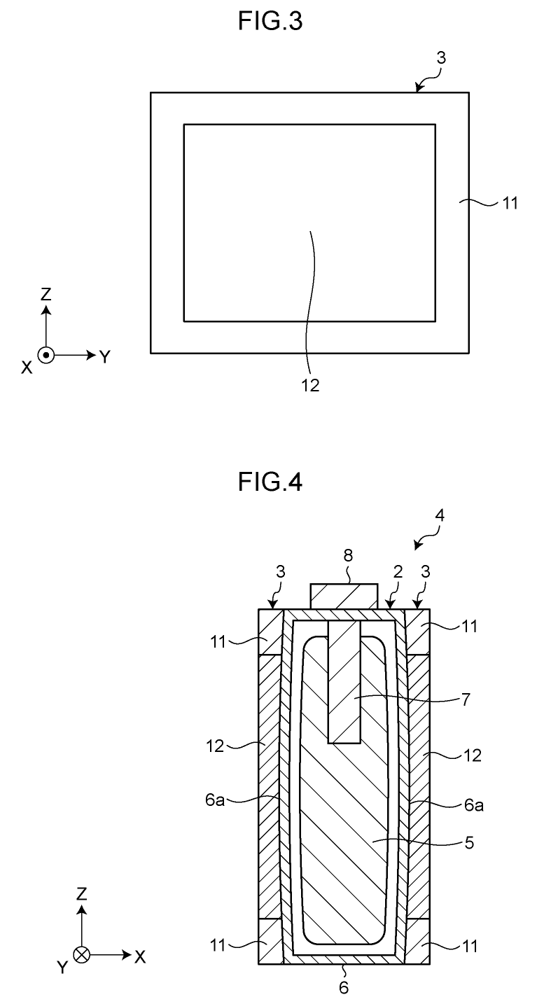

The first elastic member 11 is an elastic member for holding the electrode body 5. The first elastic member 11 is harder than the second elastic member 12. The hardness of the first elastic member 11 is higher than the hardness of the second elastic member 12. As illustrated in FIG. 3, the insulating material 3 is formed into a square shape when viewed from the stacking direction. The first elastic member 11 is formed in a rectangular frame shape to form the peripheral edge of the insulating material 3. As illustrated in FIG. 2, the thickness of the first elastic member 11 is the same as the thickness of the second elastic member 12. The first elastic member 11 is formed in a frame shape along the peripheral edge of the laminated surface 6a when viewed from the laminated direction. The first elastic member 11 contacts the peripheral edge of the laminated surface 6a. As illustrated in FIG. 2, because the electrode body 5 needs to be held in place at low SOC or low temperatures, the first elastic member 11, made of a stiffer material, is positioned at the portion contacting the peripheral edge of the laminated surface 6a. Note that FIG. 2 illustrates the case where the battery cell 2 has contracted.

The second elastic member 12 is an elastic member that receives stress from the battery cell 2. The second elastic member 12 is softer than the first elastic member 11. As illustrated in FIG. 2 and FIG. 3, the second elastic member 12 is provided inside the first elastic member 11. The first elastic member 11 and the second elastic member 12 are integrated. The second elastic member 12 is formed into a substantially rectangular shape when viewed in the stacking direction. The second elastic member 12 faces the central portion of the stacking surface 6a in the stacking direction. The second elastic member 12 contacts the central portion of the stacking surface 6a. As illustrated in FIG. 4, when the battery cell 2 expands, the second elastic member 12 elastically deforms to absorb the amount of deformation caused by the swelling of the battery cell 2. The second elastic member 12 is composed of a material having the characteristic of reduced hardness at high temperatures and increased hardness at low temperatures. That is, the second elastic member 12 is composed of a material exhibiting temperature dependence of hardness.

The insulating material 3 holds the case 6 by placing a material with temperature-dependent hardness in its inner portion contacting the central part of the laminated surface 6a. Since the battery cell 2 swells at high SOC or high temperatures and this deformation must be absorbed, the second elastic member 12, made of a material with temperature-dependent hardness, is placed in the portion contacting the central part of the laminated surface 6a. Since the load on battery cell 2 varies with temperature, the load on insulating material 3 increases as battery cell 2 expands at higher temperatures.

The insulating material 3 can be utilized in the same shape by changing the elastic material according to battery capacity or vehicle usage. At high temperatures, the battery cell 2 expands; at low temperatures, it contracts. At high SOC, the battery cell 2 expands; at low SOC, it contracts. With aging degradation, the battery cell 2 expands; when new, it contracts. SOC, years of use, charge/discharge cycles, and battery capacity are also factors affecting the load on the insulating material 3. It is desirable for the first elastic member 11 and the second elastic member 12 to be made of materials with appropriate hardness corresponding to these factors. To ensure the insulation material 3 is suitable for the battery cell 2's usage and characteristics, the hardness ratio between the material of the outer first elastic member 11 and the material of the inner second elastic member 12 is mapped. This allows the same shape to accommodate any usage scenario or battery cell 2. Materials whose hardness varies with temperature are used for the first elastic member 11 and the second elastic member 12, enabling functional retention even when the operating temperature range is expanded.

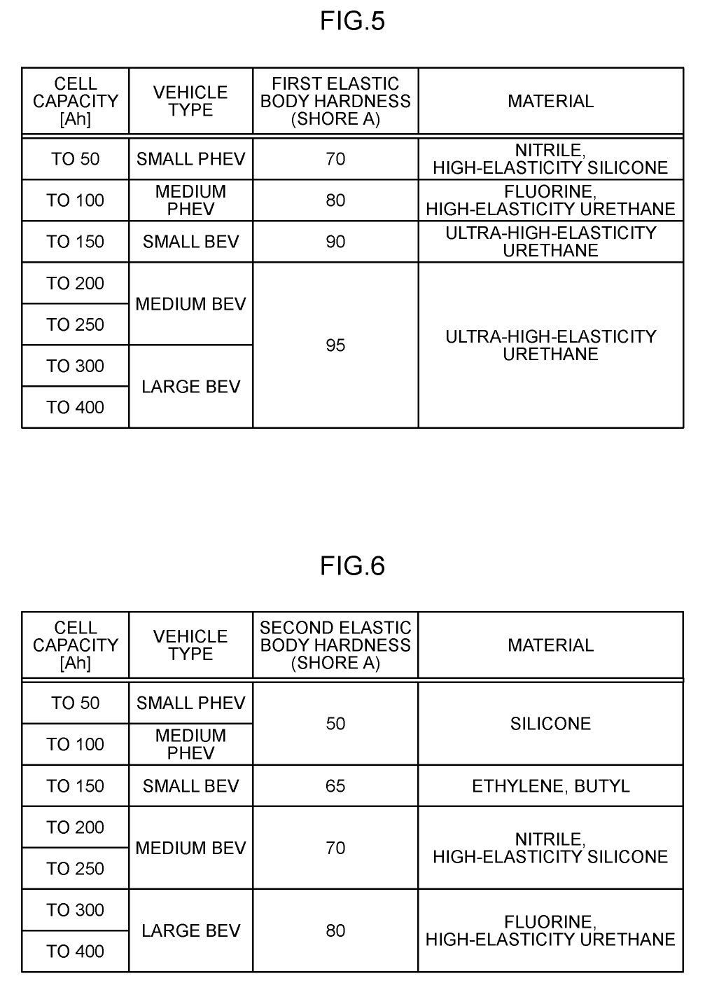

As illustrated in FIG. 5 and FIG. 6, regardless of the vehicle model in which the battery module 1 is installed, the hardness of the first elastic member 11 is always higher than that of the second elastic member 12.

As illustrated in FIG. 5, the hardness of the first elastic member 11 increases as the cell capacity increases. When the cell capacity is small, the number of charge/discharge cycles of the battery cell 2 increases, and swelling due to SOC fluctuations occurs. Therefore, the material of the first elastic member 11 is softer than when the cell capacity is large. At higher operating temperatures, swelling due to temperature fluctuations in the battery cell 2 occurs, so the material of the first elastic member 11 is softer than when the operating temperature is lower. The material constituting the first elastic member 11 can be determined according to the type of electric vehicle in which the battery module 1 is installed.

As illustrated in FIG. 6, the hardness of the second elastic member 12 increases as the cell capacity increases. When the cell capacity is small, the number of charge-discharge cycles of the battery cell 2 increases, and swelling due to SOC fluctuations occurs. Therefore, the material of the second elastic member 12 is softer than when the cell capacity is large. When the operating temperature is high, swelling due to temperature fluctuations in the battery cell 2 occurs, so the material of the second elastic member 12 is softer than when the operating temperature is low. The material constituting the second elastic member 12 can be determined according to the type of electric vehicle in which the battery module 1 is installed. When the cell capacity is large, the number of expansion-contraction cycles until EOL is high, so a softer material is used to increase the absorption amount.

As described above, according to the embodiment, the insulating material 3 can follow the load changes caused by the expansion and contraction of the battery cell 2 within the laminate 4. Furthermore, it can accommodate variations in SOC and temperature conditions and prevent damage to the battery cell 2 and module components even as the vehicle lineup expands.

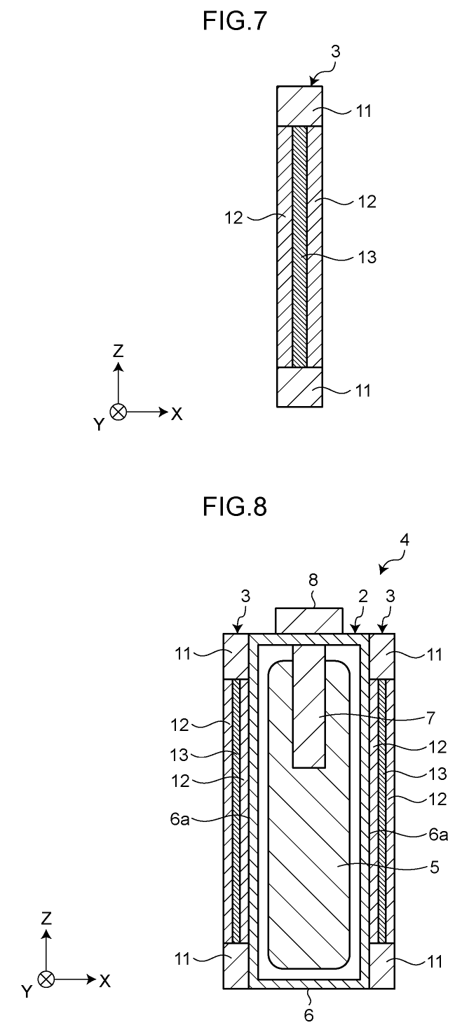

The configuration of the insulating material 3 is not limited to the structures illustrated in FIG. 2, etc. As illustrated in FIG. 7, the insulating material 3 may also have a structure where an insulation material 13 is provided inside the elastic member. The insulation material 13 is a plate-like member that does not contact the laminated surface 6a.

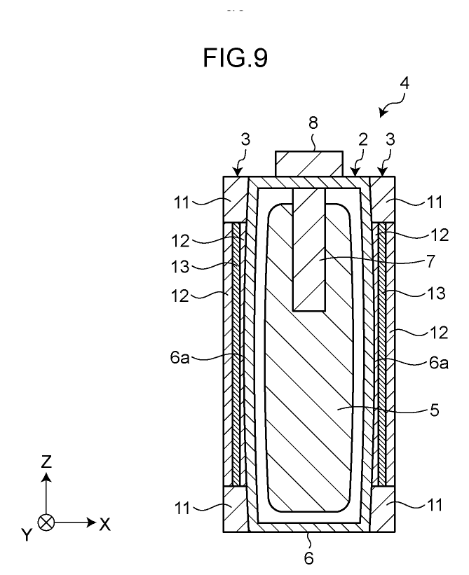

As illustrated in FIG. 7 to FIG. 9, the insulating material 3 includes a heat insulation material 13 disposed inside the first elastic body 11 and the second elastic body 12. The heat insulation material 13 is electrically insulating and is composed of a resin containing elastic components, such as an elastomer. This allows it to absorb the deformation amount during expansion of the battery cell 2 and to hold the electrode body 5 during contraction of the battery cell 2. The insulation material 13 is positioned inside the first elastic body 11 when viewed in the stacking direction and is stacked in the stacking direction with the second elastic body 12. The insulation material 13 forms an insulating layer inside the second elastic body 12. The second elastic body 12 includes a first elastic layer contacting the central portion of the adjacent battery cell 2 on one side of the stacking direction and a second elastic layer contacting the central portion of the adjacent battery cell 2 on the other side of the stacking direction. The second elastic layer is stacked with the first elastic layer via the insulation material 13. Inside the first elastic member 11, a three-layer structure is formed, including the second elastic member 12 as the first elastic layer, the insulation material 13 as the insulating layer, and the second elastic member 12 as the second elastic layer.

Furthermore, the hardness and material of the second elastic body 12 can be determined by comprehensively considering cell capacity, SOC, and operating temperature. For example, the hardness of the second elastic body 12 is determined using a hardness coefficient. The hardness coefficient is set for each of cell capacity, SOC, and operating temperature. The relationship between cell capacity and the hardness coefficient is such that the hardness coefficient increases as cell capacity increases. The relationship between SOC and the hardness coefficient is such that the hardness coefficient decreases as SOC increases. The relationship between operating temperature and the hardness coefficient is such that the hardness coefficient decreases as operating temperature increases. The hardness coefficient determined by cell capacity, the hardness coefficient determined by SOC, and the hardness coefficient determined by operating temperature are each calculated. The hardness of the second elastic body 12 is determined based on the sum of these calculated values. A larger sum value results in higher hardness.

According to the present disclosure, within a structure having a laminate including alternately stacked battery cells and plate-like members, the plate-like members can follow load changes caused by expansion and contraction of the battery cells.

Although the disclosure has been described with respect to the specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery module comprising:
battery cells each including a case and an electrode body housed inside the case; and
plate-shape insulators,
wherein the battery cells and the insulators are alternately laminated in a first direction,
each of the insulators includes an elastic member in contact with a laminated surface of the case facing the first direction;
the elastic member includes
a first elastic member formed in a frame shape along a periphery of the laminated surface as viewed from the first direction and contacting the periphery, and
a second elastic member disposed inside the first elastic member as viewed from the first direction, the second elastic member being formed in a substantially rectangular shape so as to face and contact a central portion of the laminated surface,
hardness of the first elastic member is higher than hardness of the second elastic member, and
the second elastic member is made of a material having characteristic of decreasing hardness at high temperatures and increasing hardness at low temperatures.

2. The battery module according to claim 1, wherein a thickness of the second elastic member is identical to a thickness of the first elastic member.

3. The battery module according to claim 1, wherein
each of the insulators includes an insulation material disposed within the elastic member without contacting the laminated surface,
the insulation material is disposed inside the first elastic member when viewed from the first direction, laminated with the second elastic member in the first direction, and
the second elastic member includes
a first elastic layer contacting the central portion of the battery cell adjacent to one side of the first direction, and
a second elastic layer laminated with the first elastic layer via the insulation material and contacting the central portion of the battery cell adjacent to an other side of the first direction.
